(19) United States
(12) Patent Application Publication
(10) Pub. No.: US 2024/0310492 A1
(43) Pub. Date: Sep. 19, 2024

(54) OPTOELECTRONIC SENSOR

(71) Applicant: SICK AG, Waldkirch (DE)

(72) Inventors: Fabian Tobias WÜLKER, Waldkirch (DE); Ulrich ZWÖLFER, Waldkirch (DE)

(21) Appl. No.: 18/605,535

(22) Filed: Mar. 14, 2024

(30) Foreign Application Priority Data
Mar. 15, 2023 (DE) 102023106439.8
May 16, 2023 (DE) 102023112945.7

(51) Int. Cl. G01S 7/481; G01S 7/4865

(52) U.S. Cl. CPC G01S 7/4816; G01S 7/4813; G01S 7/4865

(57) ABSTRACT

An optoelectronic sensor for the detection of objects in a monitored zone having a light transmitter for transmitting transmitted light, having a measurement light receiver for generating a received signal from transmitted light reflected by objects in the monitored zone, having a control and evaluation unit for determining information on objects in the monitored zone using the received signal, and having one or more optical elements that are arranged in the optical path of the transmitted light of the light transmitter such that some of the transmitted light moves into the monitored zone as detection light, wherein the optical element conducts some of the transmitted light to a reference light receiver, wherein the measurement light receiver and the reference light receiver are arranged on a semiconductor component, with the semiconductor component being arranged on a circuit board, and with the measurement light receiver only being illuminated by the portion of the transmitted light through the side of the semiconductor component facing the circuit board.

The present invention relates to an optoelectronic sensor.

Optical sensors typically have a reference channel and a measurement channel as a sensitive semiconductor component (chip) or semiconductor components. The error-free function of the semiconductor component or of the chip can only be ensured if no light moves from the reference channel to the measurement channel. This in particular applies to short times of flight on the detection of targets with a small spacing. An optical separation between the two channels is consequently necessary.

The semiconductor component or the chip is as small as possible to reduce the required construction space and the costs, whereby the two optical surfaces or channels are disposed close to one another. Chips or semiconductor components are furthermore electrically connected by bonding wires, whereby a potting with an encapsulation material for microelectronic applications (glob top) becomes necessary that is geometrically very undefined. It is therefore only possible with difficulty, or not at all possible in the extreme case, to apply a barrier between the two channels under economic conditions.

There are different packages to implement separations between the transmitter and the receiver. A reference element is arranged in the chamber of the transmitter in some cases. There are moreover packages that comprise the measurement channel and the reference channel in the same chamber as the transmitter. However, they only enable measurements from a certain distance onward since the measurement channel is blind for the light reflected by the detection object for a short time after the first reference pulse.

An object of the invention comprises providing an improved optoelectronic sensor that should have an improved optical separation between the measurement light receiver and the reference light receiver.

The object is satisfied by an optoelectronic sensor for the detection of objects in a monitored zone having a light transmitter for transmitting transmitted light, having a measurement light receiver for generating a received signal from transmitted light reflected by objects in the monitored zone, having a control and evaluation unit for determining information on objects in the monitored zone using the received signal, and having at least one optical element that is arranged in the optical path of the transmitted light of the light transmitter such that some of the transmitted light moves into the monitored zone as detection light, wherein one or more optical elements conducts some of the transmitted light to a reference light receiver, wherein the measurement light receiver and the reference light receiver are arranged on a semiconductor component, wherein the semiconductor component is arranged on a circuit board, and wherein the reference light receiver is only illuminated by the portion of the transmitted light through the side of the semiconductor component facing the circuit board.

The control and evaluation unit is configured to carry out a reference measurement using the signal of the reference light receiver.

The light of the measurement light receiver as the measurement channel is, for example, acted on by interference light, but not the reference light of the reference light receiver as the reference channel. Interference light can thereby, for example, be identified by the sensor.

Two chambers no longer have to be formed for the two channels, that is for the measurement light receiver and the reference light receiver, on one side of the semiconductor component or chip, but the semiconductor component itself or the circuit board on which the semiconductor component is applied now rather forms the separation. An optical separation between the measurement channel and the reference channel or between the measurement light receiver and the reference light receiver is thus improved and simplified.

Measurements of objects can thereby also be optically carried out at a small distance. The optical reference signal has the advantage with respect to the electronic reference signal that it is independent of aging influences and temperature influences and electronic influences. A distance determination of the detection object is consequently possible with a higher accuracy without any influence of this interference value.

The semiconductor component is here light transmitting to a limited extent such that some of the transmitted light can pass through the semiconductor component and is incident on the reactive surface of the reference light receiver. The direction of the portion of the transmitted light that is incident on the reference light receiver is directed here such that only the reference light receiver is impinged and not the measurement light receiver.

The reference light is incident on the silicon crystal in a sufficiently directed manner that only the active surface of the reference light receiver is illuminated. The light propagation in the silicon crystal is sufficiently low that there is no critical triggering of the actual measurement light receiver. This is in particular the case when the semiconductor component or the chip or the silicon crystal is thin.

The semiconductor component or the chip is installed, for example, as a COB (chip on board), i.e. there is, for example, no housing, but the silicon crystal is adhesively bonded directly to the circuit board. The electrical contact is established with bonding wires from the landing pads on the crystal to the landing pads on the circuit board.

Wafers of typically 725 μm can, for example, be thinned down to 10 μm for the back side illumination. The optimum here is e.g. at approximately 50 μm for near infrared light (NIR, from ˜ 850 nm to 900 nm).

The semiconductor component can, for example, also comprise through silicon vias, TSVs). The term silicon through via is understood in semiconductor technology as an electrical connection of e.g. copper, tungsten, or similar suitable metals by a silicon substrate (wafer, chip), for example the semiconductor component. The silicon through via technology is a promising possibility of implementing electrical connections between chips in the integration of integrated circuits.

The circuit board itself is here at least conditionally light permeable for the portion of the transmitted light that is directed to the reference light receiver beneath the region of the reference channel. The portion of the transmitted light radiates through the circuit board at the point at which the semiconductor component having the reference light receiver is arranged.

The transmitted light can, for example, be infrared light, visible red light, and also, for example, preferably laser light.

In a further development of the invention, the measurement light receiver and the reference light receiver are time of flight receivers.

In accordance with the further development, the exact time of the transmission of light to the light transmitter can be determined by the reference light receiver.

In accordance with the further development, the optoelectronic sensor is a distance measuring light sensor in accordance with the time of flight principle, with the control and evaluation unit being configured to determine an object distance from a time of flight between the transmission of the transmitted light and the reception of the reflected transmitted light.

In this respect, light pulses or, for example, light pulse groups are transmitted.

Time of flight measurement systems make the distance measurement possible by determining the time difference between the transmission of the light and the return of the light reflected by the measurement object. The time of the transmission of the light is determined by the reference measurement. It is advantageous for the time of flight measurement if an optical reference measurement is present, whereby the accuracy of the reference measurement is increased. For this purpose, the light is decoupled by the optical element or the light guide and conducted to the reference detection surface of the reference light receiver. The time of flight can thus be determined very accurately since the exact time of the light transmission and the exact time of the light reception are known to the control and evaluation unit.

The light is conducted to the reference light receiver at a sufficient intensity by the optical element, whereby a precise and stabile time of flight measurement is made possible.

The measurement light receiver is an avalanche photodiode element, for example. Optionally, the reference light receiver can also be an avalanche photodiode element.

An optoelectronic sensor is thus optionally formed for determining the distance of an object in the monitored zone in accordance with a pulse-based time of flight process having a light transmitter for transmitting a light pulse, having a measurement light receiver, with at least one avalanche photodiode element being configured as a measurement reception element and receiving the light pulse remitted by the object, and at least one avalanche photodiode element being configured as a reference reception element and receiving some of the transmitted light pulse within the sensor as the reference pulse, and having the control and evaluation unit, that is configured to determine a time of flight between the transmission of the light pulse and the reception of the remitted light pulse and from this the distance of the object, from the received signals of the measurement reception element and of the reference reception element.

The measurement light receiver can also be formed as a single photon avalanche diode or from an array of single photon avalanche diodes.

Single photon avalanche diodes are also synonymously called “single photon avalanche diodes” or SPADs. Other common terms are ‘silicon photomultiplier’ (SiPM). ‘Geiger mode avalanche photodiode’ or ‘single photon counting diode’. Single photo avalanche diodes are photosensitive detectors which can be implemented in standard CMOS technology and which, in a similar manner to avalanche photodiodes, convert incident photons into current pulses. Unlike avalanche photodiodes, however, single photon avalanche diodes are operated over an avalanche voltage. A single incident photon thus already triggers an avalanche effect which can be detected as a current pulse. Due to the high sensitivity, namely a gain factor of 10⁶, even the smallest received powers down to single photons can be detected.

Different time of flight methods with a corresponding evaluation can be implemented for the distance measurement.

The time of flight sensor, for example, works according to a direct time of flight process (dTOF), according to which brief light pulses or light pulse groups are transmitted and the time up to the reception of a remission or reflection of the light pulses at an object is measured. The light signals are here formed by light pulses.

On the one hand, the optical distance measurement for the direct time of flight (dTOF) process requires the time detection of the transmitted light pulse (e.g. laser light) and, on the other hand, the time detection of the received light reflected by an object or target. In SPAD dTOF systems, the first incident photons are evaluated. The transmitted pulse often shows a length of up to approximately 3 ns. Superposed received pulses over approximately ½ meter can, for example, not be detected in this time window. An optical decoupling or separation is thus important and both events have to be able to be detected independently of one another and without mutual influencing.

However, other time of flight processes are also possible, for example the phase process, according to which transmitted light is amplitude modulated and a phase shift between the transmitted light and the received light is determined, with the phase shift likewise being a measure for the time of flight (indirect time of flight process, iTOF).

Furthermore, a CW (continuous wave) process can be used, with a light signal being used which is constant in time. In this process, for example, the single photon events are distributed via a gating signal into two counters and a phase is calculated from the ratio of the counts.

The at least one light transmitter is preferably a laser diode. They are, for example, VCSEL laser diodes that have a very good price/performance ratio.

A pulse method can be provided. For example, one or more time-to-digital converters can be provided for the pulse method in which each single photon event is provided with a time stamp. With a wanted signal, a plurality of time stamps therefore occur in correlation. The measured value generation takes place statistically. Background light, in contrast, generates randomly distributed time stamps.

Furthermore, analog signals of the single photon diode array can be evaluated. They are compared with a threshold value, are sampled or are evaluated using statistical methods.

In the evaluation according to the time of flight process, an amplitude value can be generated in addition to the distance value, e.g. by a histogram of the time stamps, by the count rate or by the voltage amplitude in an analog evaluation. A plausibility check can be carried out by the amplitude value, in particular in technical safety applications.

The use of single photon avalanche diodes offers the following advantages: Single photon avalanche diodes can be manufactured in a standard CMOS process. The light sensor thus offers high integration capability, e.g. as an ASIC. The control and evaluation unit can likewise be integrated in the reception chip for the light transmitters, for example a VSCEL, a laser diode, or a light emitting diode.

The transmitted light is preferably laser light. Collimated light beams can thereby be generated that have a high light energy and are limited to a specific wavelength.

In a further development of the invention, the control and evaluation unit is configured to correct the time of flight using the reference measurement, for example based on times of flight over process, temperature, and voltage, whereby a precise time of flight measurement is possible. The reference light path or the length of the reference light path is known so that time shifts due to so-called drifts can be detected and compensated.

In a further development of the invention, the optical element has a transparent light guide that conducts the portion of the transmitted light to a reference light receiver.

The light guide of the optical element can be designed in any desired form, whereby the reference light receiver can be arranged at different positions. A glass fiber can, for example, be used as the light guide. The transparent light guide is here, for example, perpendicular to the optical axis of the transmitted light. A coupling element of the light guide is here disposed in the region of the transmitted light path. A decoupling region of the light guide is here disposed opposite the reception surface of the reference light receiver on the rear side of the semiconductor component. The light guide is based, for example, on the effect of the total reflection at the boundary surfaces. After the entry of the light into the light guide, the light is totally reflected, for example, multiple times at the boundary surfaces and finally moves to the reference light receiver via the decoupling region. A partial reflection can, however, also be provided. The light guide is preferably disk-shaped or planar, with a main plane of the disk-shaped or planar light guide preferably being perpendicular to the optical axis of the transmitted light.

The light guide comprises a material that is transparent to the transmitted light and that, for example, leads to the total reflection at the boundary surface air. The light guide comprises plastic, for example. The light guide can, however, also comprise glass, for example.

The light guide, for example, has geometrical, optical, diffractive, and/or refractive structures at a coupling point for the transmitted light. These structures improve the efficiency of the coupling point. The geometrical or optical structures can be stair-like steps or, for example, mirror elements. Refractive structures can comprise lens elements, for example.

In a further development of the invention, the optical elements have a plurality of reflective surfaces that conduct some of the transmitted light to a reference light receiver. Reflective surfaces have the advantage that practically any desired light paths can be implemented by them. Reflective surfaces can be inexpensively implemented and can be integrated in mechanical sensor components.

In a further development of the invention, the optical element has a diaphragm with an aperture for the transmitted light.

To ensure a diaphragm function, the diaphragm is located on a side or surface of the optical element remote from the light transmitter. The diaphragm is likewise preferably arranged perpendicular to the optical axis of the transmitted light. The diaphragm comprises a light impermeable material. The diaphragm preferably has a reflective surface that is arranged facing the light transmitter. The light transmitter is arranged between the diaphragm and the light transmitter. The surface of the light guide can be correspondingly formed in the region of the diaphragm to facilitate a coupling of some of the transmitted light into the light guide. Reflections from the light transmitter are intercepted or covered by the diaphragm and are kept away from the transmission region. An illumination of marginal regions of the lens, in particular of a collimator lens, are furthermore prevented by the diaphragm since these regions are covered by the diaphragm.

Scattered light and a deterioration of the light spot associated therewith is thereby avoided.

The construction space to decouple light from the transmission region is minimized and thus small. The cross-section of the transmitted light beam of the light transmitter is not negatively influenced. The diaphragm is not subject to any restrictions by the light guide, whereby the diaphragm function is present without limitation. The optical element satisfies the diaphragm and light guide function in accordance with the further development. A synergy effects is thereby achieved. The number of parts is thereby reduced and the assembly of the sensor is simplified, whereby the sensor can be manufactured less expensively.

The diaphragm and the light guide are already aligned and fixed with respect to one another by an optional connection with material continuity between the diaphragm and the light guide.

The aperture of the diaphragm is a circular opening, for example. The light cross-section of light transmitters, light emitting diodes, for example, is frequently oval, frequently subject to tolerances, or, for example, frequently undefined in the marginal regions. A circular light beam is generated by the circular aperture of the diaphragm. The circular light beam is projected onto an object by the lens or the collimator lens, for example. The light spot on the object is in turn detected on the measurement light receiver and results in an object determination signal that is generated by the control and evaluation unit.

The optical element is, for example, manufactured with the light guide and the diaphragm as a two-component injection molded part. The optical element can thereby be manufactured in one workstep, whereby the optical element can be manufactured very inexpensively.

The diaphragm is, for example, a diaphragm film or a metal diaphragm. In this respect, the light guide and the diaphragm film or the metal diaphragm are two parts that are joined together. Different diaphragms and different light guides can thereby, for example, also be simply be combined with one another. The light guide and the diaphragm film or the metal diaphragm can be joined together with material continuity, for example.

The diaphragm is, for example, a light impermeable coating of the light guide. The diaphragm can thereby be implemented in a very simple manner. In the simplest case, the diaphragm can, for example, be printed, vapor deposited, or lacquered. The optical element can thereby be manufactured very inexpensively. Since the diaphragm is a coating, the diaphragm and thus the margin of the diaphragm that forms the aperture of the diaphragm can have a very precise design. The margin of the diaphragm thereby also has an acute, circular edge.

In a further development of the invention, the circuit board has an opening at the position of the reference light receiver. The circuit board, for example, has a bore at the position of the reference light receiver. Provision can, however, also be made, for example, that the circuit board has a reduced depth or thickness at the position of the reference light receiver. The opening of the circuit board can, for example, be a hollow contact of the circuit board so that a cylindrical metal opening is formed, whereby no light can exit transversely to the opening due to the metallic jacket.

In a further development of the invention, the transparent light guide is integrated in the circuit board. The transparent light guide is here, for example, integrated on the surface of the circuit board or is integrated as an integrated intermediate layer of the circuit board. The circuit board and the light guide, for example, form a single-piece component here.

In a further development of the invention, the reference light receiver on the semiconductor component is cast with a potting agent on the s ide remote from the circuit board.

The casting with the potting agent is, for example, a flexible and solid encapsulation that hardens under UV light, visible light, or thermally and that protects exposed components, in particular the reference light receiver or the measurement light receiver. However, integrated circuits or wire connections are also thereby secured. Special adhesives are used for this purpose, for example.

Protection is thus formed of particularly sensitive components from scratching or mechanical loads. The potting compounds used are UV hardening as a rule. The hardening can already take place within a few seconds depending on the material used. The sealing of the parts or components can take place fully automatically.

Potting compounds that harden thermally have the advantage that they also harden when no light is present such as in dark rooms or in shadow zones. The potting compounds can be loaded for a brief period up to 280° C. after hardening has taken place. They thereby withstand a reflow process without harm.

The potting compound encapsulates the chip and so ensures that sensitive wire contacts do not break off. At the same time, there is protection from scratching, moisture, and dust.

Potting compounds, for example glob top, belong to the methods of liquid encapsulation. The aim is to protect electronic components with a liquid substance at room temperature. No product-specific tools are required for this. Single component or two-component potting compounds are selectively used.

They are largely based on epoxide resin, silicone, polyurethanes, or acrylate and harden thermally. They are mostly already premixed. Single-component polymer systems are also frequently used. They have the advantage that they set under UV light. The selection of the material has to take place such that the insulation properties and the electronic demands are considered.

The invention will also be explained in the following with respect to further advantages and features with reference to the enclosed drawing and embodiments. The Figures of the drawing show in:

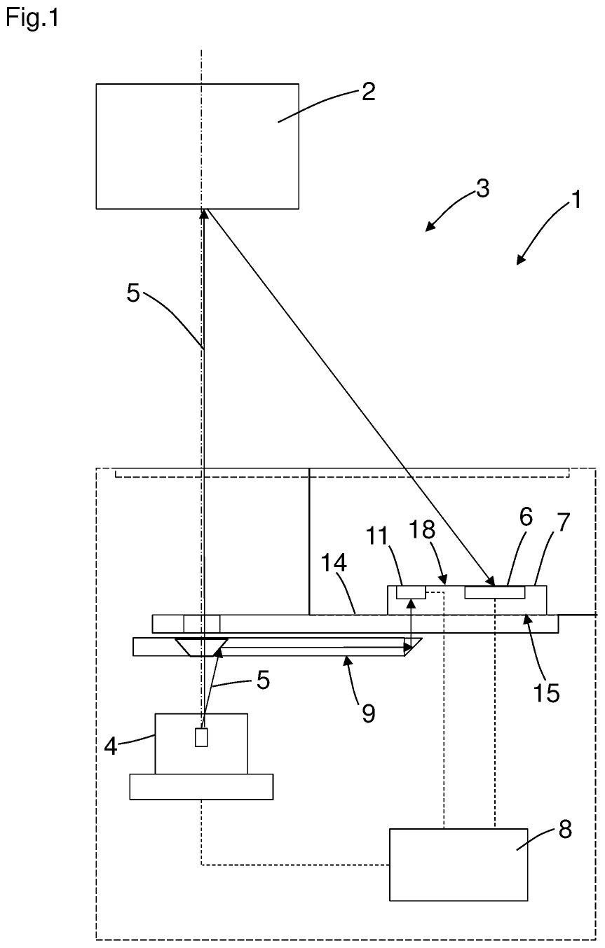

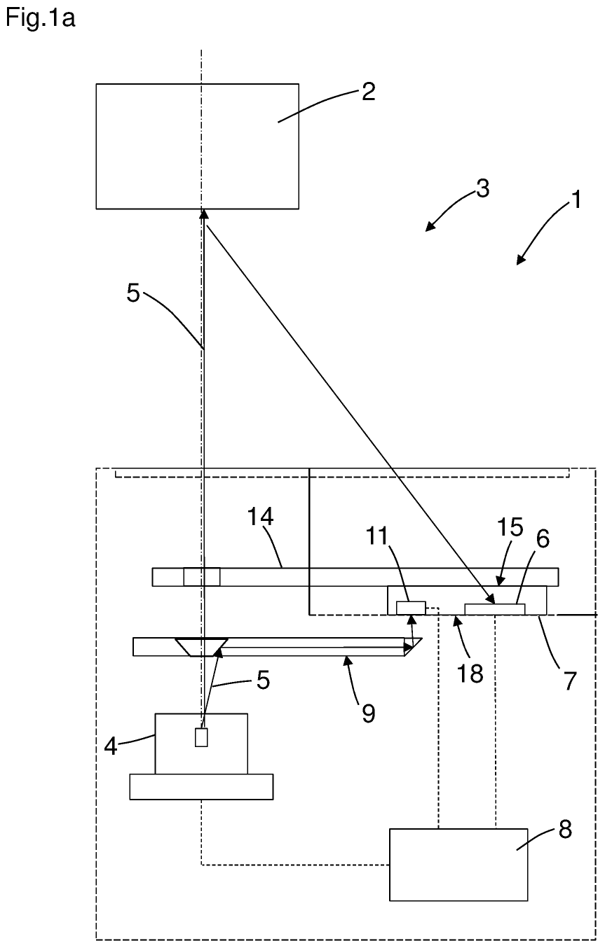

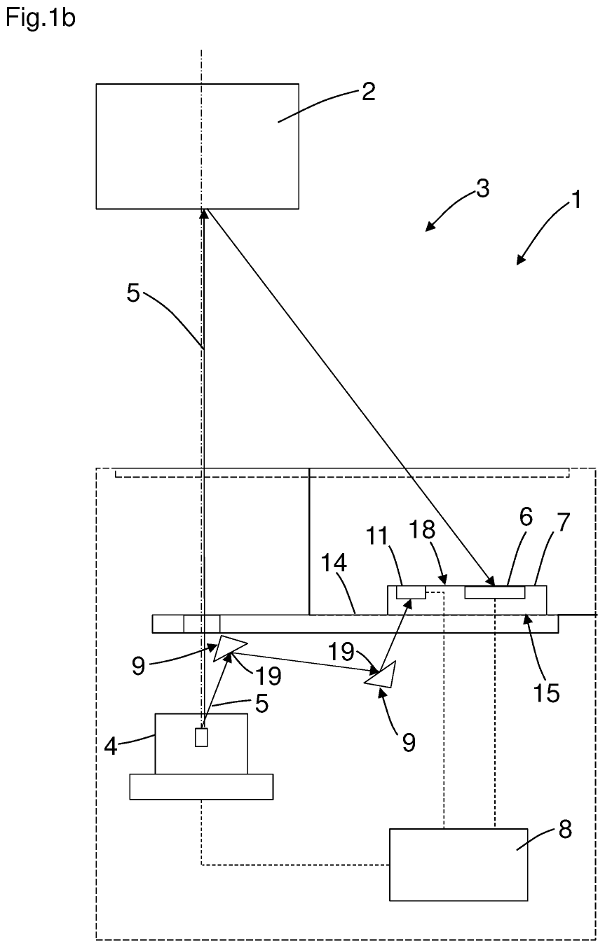

FIG. 1 to FIG. 4 respectively an optoelectronic sensor;

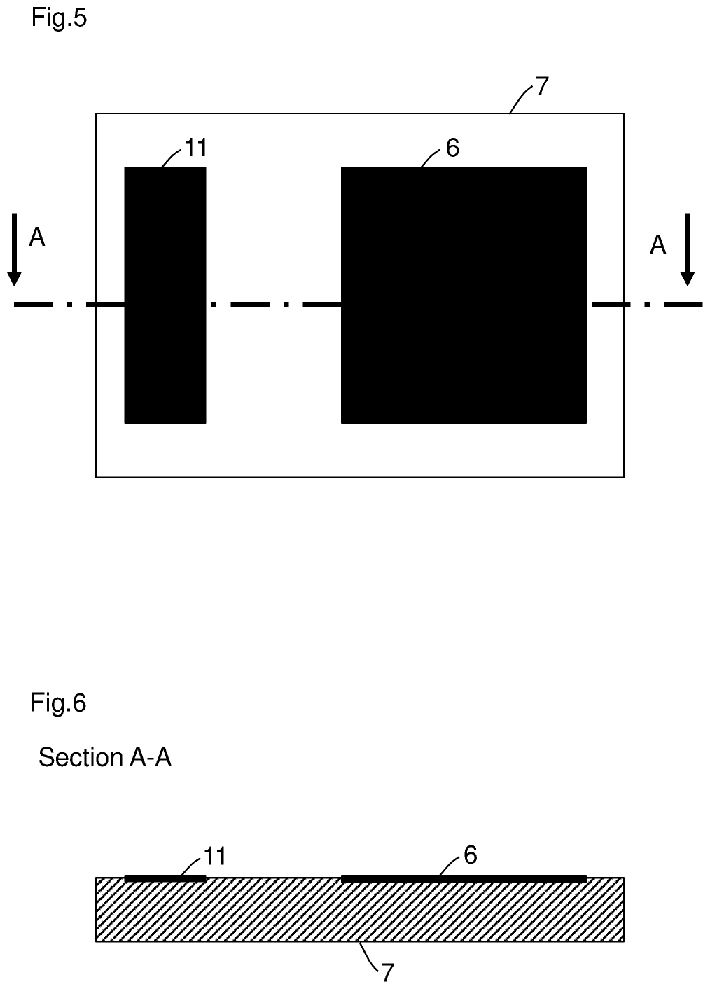

FIG. 5 a semiconductor component in a plan view;

FIG. 6 a sectional representation in accordance with FIG. 5;

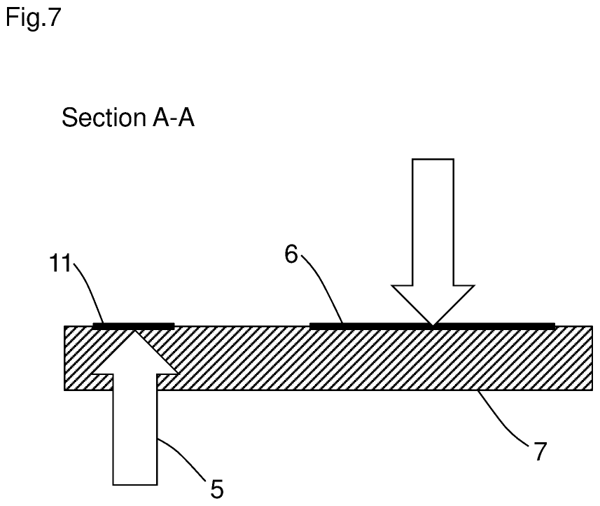

FIG. 7 the semiconductor component in accordance with FIG. 5 in a cross-sectional representation;

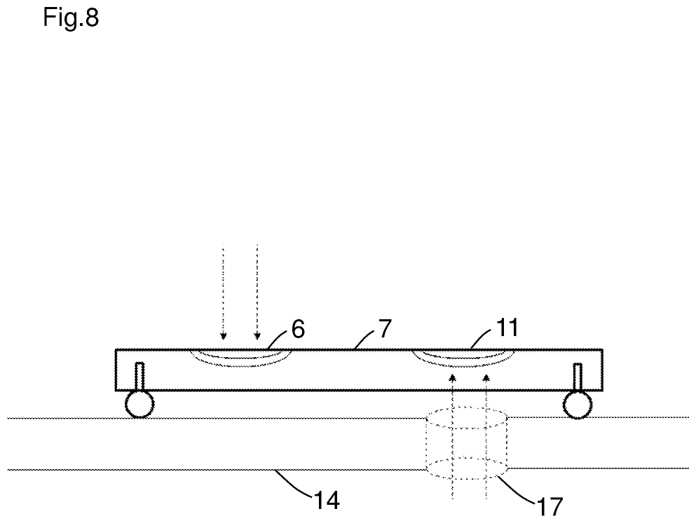

FIG. 8 a semiconductor component in a cross-sectional side view.

In the following Figures, identical parts are provided with identical reference numerals.

FIG. 1 shows an optoelectronic sensor 1 for the detection of objects 2 in a monitored zone 3 having a light transmitter 4 for transmitting transmitted light 5, having a measurement light receiver 6 for generating a received signal from transmitted light 5 reflected by objects 2 in the monitored zone 3, having a control and evaluation unit 8 for determining information on objects 2 in the monitored zone 3 using the received signal, and having at least one optical element 9 that is arranged in the optical path of the transmitted light 5 of the light transmitter 4 such that some of the transmitted light 5 moves into the monitored zone 3 as detection light, wherein one or more optical elements 9 conduct some of the transmitted light 5 to a reference light receiver 11, wherein the measurement light receiver 6 and the reference light receiver 11 are arranged on a semiconductor component, wherein the semiconductor component is arranged on a circuit board 14, and wherein the reference light receiver 11 is only illuminated by the portion of the transmitted light 5 through the side of the semiconductor component 7 facing the circuit board 14.

The optoelectronic sensor in accordance with FIG. 1 has a sensor housing 20 and a front screen 21. The sensor is separately divided in the interior of the sensor housing 20, for example, into a transmission space 22 and a reception space 23. The reception space 23 is optically isolated from the transmission space 22.

The control and evaluation unit 8 is configured to carry out a reference measurement using the signal of the reference light receiver 11. The control and evaluation unit 8 can, for example, also be integrated in the semiconductor component 7.

The light of the measurement light receiver 6 as the measurement channel is, for example, acted on by interference light, but not the reference light of the reference light receiver 11 as the reference channel. Interference light can thereby, for example, be identified by the optoelectronic sensor 1.

The semiconductor component 7 is light permeable to the extent that some of the transmitted light 5 can pass through the semiconductor component 7 and is incident on the reference light receiver 11. The semiconductor component 7, for example, has a small thickness of, for example, 10 μm to 750 μm. The direction of the portion of the transmitted light 5 that is incident on the reference light receiver 11 is directed here such that only the reference light receiver 11 is impinged and not the measurement light receiver 6.

Wafers of typically 725 μm can, for example, be thinned down to 10 μm for the back side illumination. The optimum here is e.g. at approximately 50 μm for NIR (˜850 nm to 900 nm).

The following table (Source: Hamamatsu) provides an overview of the penetration depth of light at different wavelengths in silicone crystal as the semiconductor component.

| | Penetration |
|---|---|
| Wavelength | depth |
| (nanometers) | (micrometers) |
| 400 | 0.19 |
| 450 | 1.0 |
| 500 | 2.3 |
| 550 | 3.3 |
| 600 | 5.0 |
| 650 | 7.6 |
| 700 | 8.5 |
| 750 | 16 |
| 800 | 23 |
| 850 | 46 |
| 900 | 62 |
| 950 | 150 |
| 1000 | 470 |
| 1050 | 1500 |
| 1100 | 7600 |

The semiconductor component 7 is here fully or almost impermeable for light between the measurement light receiver 6 and the reference light receiver 11. This is achieved, for example, by a small aspect ratio of the chip height to the distance between the measurement light receiver 6 and the reference light receiver 11.

The circuit board 14 itself is here partially light permeable for the portion of the transmitted light 5 that is directed to the reference light receiver 11. The portion of the transmitted light 5 radiates through the circuit board 14 at the point at which the semiconductor component 7 having the reference light receiver 11 is arranged. The light permeability is e.g. achieved by a bore in the circuit board.

The transmitted light 5 can, for example, be infrared light, visible red light, and also, for example, preferably laser light.

FIG. 1a shows an optoelectronic sensor 1 for the detection of objects 2 in a monitored zone 3 having a light transmitter 4 for transmitting transmitted light 5, having a measurement light receiver 6 for generating a received signal from transmitted light 5 reflected by objects 2 in the monitored zone, 3 having a control and evaluation unit 8 for determining information on objects 2 in the monitored zone 3 using the received signal, and having at least one optical element 9 that is arranged in the optical path of the transmitted light 5 of the light transmitter 4 such that some of the transmitted light 5 moves into the monitored zone 3 as detection light, wherein one or more optical elements 9 conduct some of the transmitted light 5 to a reference light receiver 11, wherein the measurement light receiver 6 and the reference light receiver 11 are arranged on a semiconductor component 7, wherein the semiconductor component 7 is arranged on a circuit board 14, and wherein the measurement light receiver 11 is only illuminated by the portion of the transmitted light 5 through the side 15 of the semiconductor component 7 facing the circuit board 14.

In accordance with FIG. 1b, the optical elements 9 have a plurality of reflective surfaces 19 that conduct some of the transmitted light 5 to a reference light receiver 11. The signal or some of the transmitted light 5 is directed by the reflective surfaces 19 onto the reference light receiver 11 through the inner sensor space.

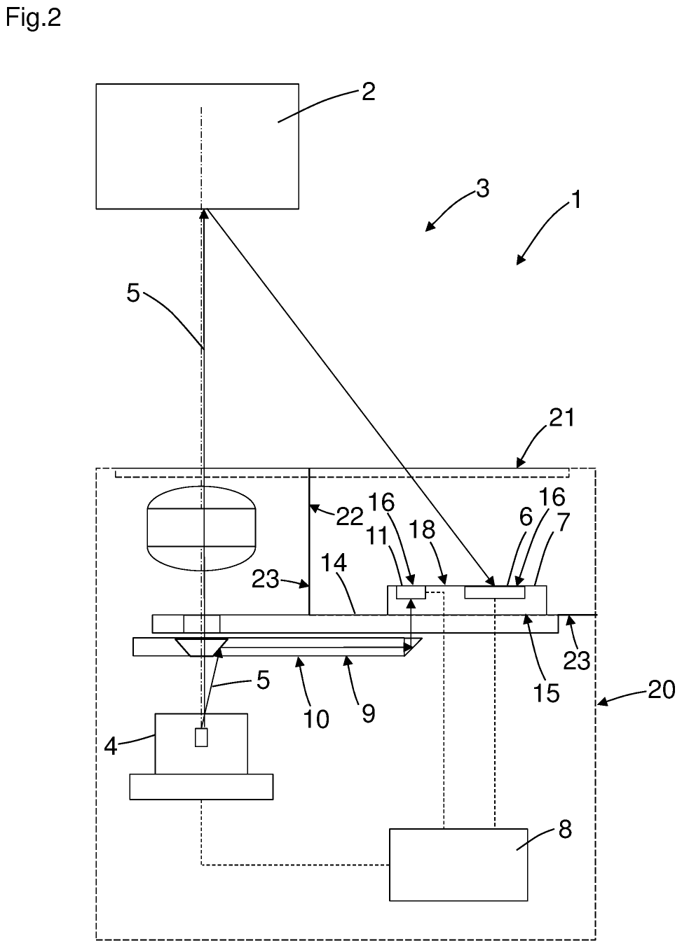

In accordance with FIG. 2, the measurement light receiver 6 and the reference light receiver 11 are time of flight receivers 16.

The optoelectronic sensor 1 in accordance with FIG. 2 has a sensor housing 20 and a front screen 21. The sensor 1 is separately divided in the interior of the sensor housing, for example, into a transmission space 22 and a reception space 23. The reception space 23 is optically isolated from the transmission space 22.

The exact time of the transmission of transmitted light 5 to the light transmitter 4 through the reference light receiver 11 can be determined by the time of flight receiver 16.

In accordance with FIG. 2, the optoelectronic sensor 1 is a distance measuring light sensor in accordance with the time of flight principle, with the control and evaluation unit 8 being configured to determine an object distance from a time of flight between the transmission of the transmitted light 5 and the reception of the reflected transmitted light 5. In this respect, light pulses or, for example, light pulse groups are transmitted.

Time of flight measurement systems make the distance measurement possible by determining the time difference between the transmission of the light and the return of the light reflected by the measurement object. The time of the transmission of the light is determined by the reference measurement. For this purpose, the transmitted light 5 is decoupled by the optical element 9 or the light guide 10 and conducted to the reference detection surface of the reference light receiver 11. The time of flight can thus be determined very accurately since the exact time of the light transmission and the exact time of the light reception are known to the control and evaluation unit 8.

The light is conducted to the reference light receiver 11 at a sufficient intensity by the optical element, whereby a precise and stable time of flight measurement becomes possible.

The measurement light receiver 6 has, for example, at least one avalanche photodiode element. Optionally, the reference light receiver 11 can also have at least one avalanche photodiode element.

In accordance with FIG. 2, an optoelectronic sensor 1 is thus optionally formed for determining the distance of an object 2 in a monitored zone 3 in accordance with a pulse-based time of flight process having a light transmitter 4 for transmitting a light pulse, having a measurement light receiver 6, having at least one avalanche photodiode element being configured as a measurement reception element and receiving the light pulse remitted by the object, and at least one avalanche photodiode element being configured as a reference reception element or as a reference light receiver 11 and receiving some of the transmitted light pulse within the sensor 1 as the reference pulse, and having a control and evaluation unit 8 that is configured to determine a time of flight between the transmission of the light pulse and the reception of the remitted light pulse, and from this the distance of the object 2, from the received signals of the measurement reception element or measurement light receiver 6 and of the reference reception element or reference light receiver 11.

The measurement light receiver 6 can also be formed as a single photon avalanche diode or from an array of single photon avalanche diodes.

The at least one light transmitter 4 is preferably a laser diode. They are, for example, VCSEL laser diodes that have a very good price/performance ratio.

The transmitted light 5 is preferably laser light. Collimated light beams can thereby be generated that have a high light energy and are limited to a specific wavelength.

The control and evaluation unit 8 is, for example, configured to correct the time of flight using the reference measurement, whereby a more accurate time of flight measurement is possible. The reference light path or the length of the reference light path is known so that time shifts due to drifts can be detected and compensated. The control and evaluation unit 8 can, for example, also be a component of the measurement light receiver 6 or of the reference light receiver 11.

In accordance with FIG. 2, the optical element 9 has a transparent light guide 10 that conducts the portion of the transmitted light 5 to a reference light receiver 11.

The light guide 10 of the optical element 9 can be designed in any desired form, whereby the reference light receiver 22 can be arranged at different positions. The transparent light guide 10 is here, for example, perpendicular to the optical axis of the transmitted light 5. A coupling element of the light guide 10 is here disposed in the region of the transmitted light beam. A decoupling region of the light guide 10 is here disposed opposite the reception surface of the reference light receiver 11 on the rear side of the semiconductor component 7. The light guide 10 is based, for example, on the effect of the total reflection at the boundary surfaces. After the entry of the light into the light guide 20, the light is totally reflected, for example, multiple times at the boundary surfaces and finally moves to the reference light receiver 11 via the decoupling region. A partial reflection can, however, also be provided. The light guide 10 is preferably disk-shaped or planar, with a main plane of the disk-shaped or planar light guide 10 preferably being perpendicular to the optical axis of the transmitted light 5.

The light guide 10 comprises a material that is transparent to the transmitted light 5 and that, for example, leads to the total reflection at the boundary surface air. The light guide 10 comprises plastic, for example. The light guide 10 can, however, 10 also comprise glass, for example.

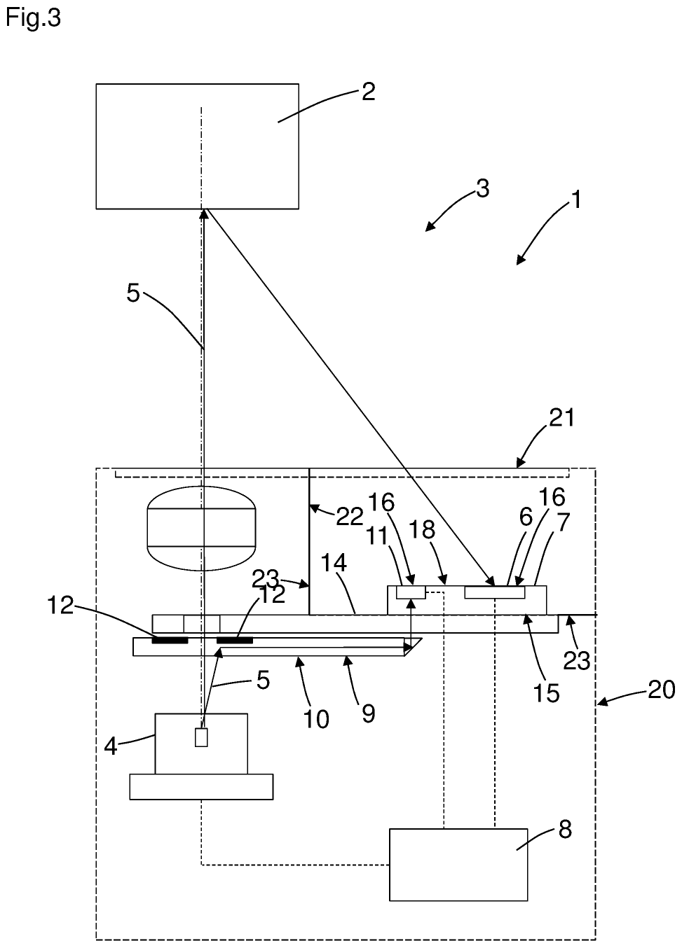

The optical element 9 in accordance with FIG. 3, for example, has a diaphragm 12 having an aperture 13 for the transmitted light 5.

To ensure a diaphragm function, the diaphragm 12 is located on a side or surface of the optical element 9 remote from the light transmitter 4. The diaphragm 12 is likewise preferably arranged perpendicular to the optical axis of the transmitted light 5. The diaphragm 12 comprises a light impermeable material. The diaphragm 12 preferably has a reflective surface that is arranged facing the light transmitter 4. The light guide 10 is arranged between the diaphragm 12 and the light transmitter 4. The surface of the light guide 10 can be correspondingly formed in the region of the diaphragm 12 to facilitate a coupling of some of the transmitted light 5 into the light guide 10.

The aperture 13 of the diaphragm 12 is a circular aperture 13, for example. A circular light beam is generated by the circular aperture 13 of the diaphragm 12. The circular light beam is projected onto an object 2 by the lens or the collimator lens, for example. The light spot on the object 2 is in turn detected on the measurement light receiver 6 and results in an object determination signal that is generated by the control and evaluation unit 8.

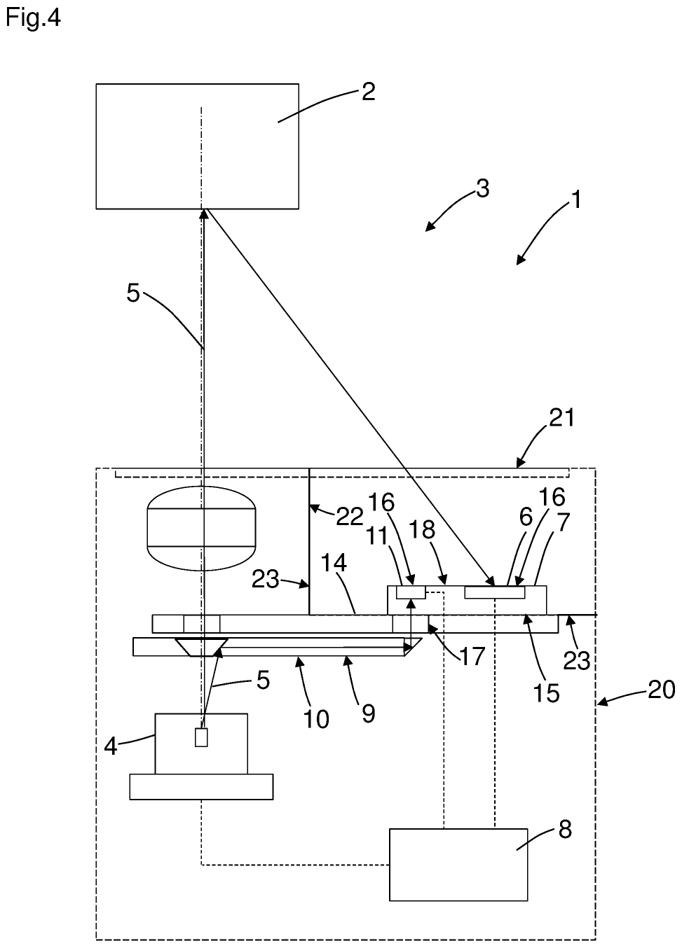

In accordance with FIG. 4, the circuit board 14 has an opening 17 at the position of the reference light receiver 11. The circuit board 14, for example, has a bore at the position of the reference light receiver 11. Provision can, however, also be made, for example, that the circuit board 14 has a reduced depth or thickness at the position of the reference light receiver 11.

The transparent light guide 10 is integrated in the circuit board 14, for example. The transparent light guide 14 is here, for example, integrated on the surface of the circuit board 14 or is integrated as an integrated intermediate layer of the circuit board 14. The circuit board 14 and the light guide 10, for example, form a single-piece component here.

The reference light receiver 11 on the semiconductor component 7 is, for example, cast with a potting agent on the side that is remote from the circuit board 14.

FIG. 5 shows the semiconductor component 7 in a plan view with the reference light receiver 11 and the measurement light receiver 6. The semiconductor component 7 is a silicon crystal, for example.

FIG. 6 shows the semiconductor component 7 in accordance with FIG. 5 in a cross-sectional representation along the line A-A with the reference light receiver 11 and the measurement light receiver 6.

FIG. 7 shows the semiconductor component 7 in accordance with FIG. 5 in a cross-sectional representation along the line A-A with the reference light receiver 11 and the measurement light receiver 6. The transmitted light 5 reaches the reference light receiver via the rear side of the semiconductor component 7 directly from the light transmitter 4 as reference light. The measurement light that was reflected from a detection object reaches the measurement light receiver 6.

FIG. 8 shows the semiconductor component 7 in a cross-sectional side view with the reference light receiver 11 and the measurement light receiver 6. The semiconductor component 7 is a silicon crystal, for example.

The semiconductor component 7 or the chip is installed as a COB (chip on board), for example. The contact is thus implemented via bonding wires, i.e. the measurement light receiver is operated via a front side illumination (FSI) and the reference light receiver is operated via a back side illumination (BSI). Alternatively, the design and connection technology can take place by through silicon vias (TSVs). The measurement light receiver can equally be implemented via a back side illumination and the reference light receiver via front side illumination,

### REFERENCE NUMERALS

1 optoelectronic sensor
2 object
3 monitored zone
4 light transmitter
transmitted light
6 measurement light receiver
7 semiconductor component
8 control and evaluation unit
9 optical element
10 transparent light guide
11 reference light receiver
12 diaphragm
13 aperture
14 circuit board
15 side of the semiconductor component facing the circuit board
16 time of flight receiver
17 opening
18 side of the semiconductor component remote from the circuit board
19 reflective surfaces
20 sensor housing
21 front screen
22 transmission space
23 reception space

1. An optoelectronic sensor for the detection of objects in a monitored zone, having a light transmitter for the transmission of transmitted light;
having a measurement light receiver for generating a received signal from transmitted light reflected by objects in the monitored zone;
having a control and evaluation unit for determining information on objects in the monitored zone using the received signal;
and having at least one optical element that is arranged in the optical path of the transmitted light of the light transmitter such that some of the transmitted light moves into the monitored zone as detection light,
wherein one or more optical elements conduct some of the transmitted light to a reference light receiver,
wherein the measurement light receiver and the reference light receiver are arranged on a semiconductor element,
with the semiconductor element being arranged on a circuit board, and the reference light receiver only being illuminated by the portion of the transmitted light through the side of the semiconductor component facing the circuit board.

2. The optoelectronic sensor in accordance with claim 1, wherein the measurement light receiver and the reference light receiver are time of flight receivers.

3. The optoelectronic sensor, in accordance with claim 1, wherein the optical element has a transparent light guide that conducts the portion of the transmitted light to a reference light receiver.

4. The optoelectronic sensor in accordance with claim 1, wherein the optical elements are a plurality of reflective surfaces that conduct some of the transmitted light to a reference light receiver.

5. The optoelectronic sensor in accordance with claim 1, wherein the optical element has a diaphragm that has an aperture for the transmitted light.

6. The optoelectronic sensor in in accordance with claim 1, wherein the circuit board has an opening at the position of the reference light receiver.

7. The optoelectronic sensor in accordance with claim 3, wherein the transparent light guide is integrated in the circuit board.

8. The optoelectronic sensor in accordance with claim 1, wherein the reference light receiver on the semiconductor component is cast with a potting agent on the side that is remote from the circuit board.
